(19) United States
(12) Patent Application Publication
(10) Pub. No.: US 2021/0209803 A1
(43) Pub. Date: Jul. 8, 2021

(54) COMPUTER-BASED METHOD AND SYSTEM FOR GEO-SPATIAL ANALYSIS

(71) Applicant: QUANTELA INC, Milpitas, CA (US)

(72) Inventors: Sanjiv Kumar Jha, Bangalore (IN); Vikash Shivhare, Madhya Pradesh (IN); Sumedh Ghatage, Kolhapur (IN); Anand Kumar Jha, Bihar (IN)

(21) Appl. No.: 16/734,605

(22) Filed: Jan. 6, 2020

(51) Int. Cl. G06T 7/00; G06F 16/29; G06F 16/587; G06F 16/54; G06K 9/62

(52) U.S. Cl. CPC G06T 7/97; G06F 16/29; G06F 16/587; G06F 16/54; G06T 2207/10048; G06T 2207/10036; G06T 2207/30188; G06T 2207/30192; G06K 9/628

(57) ABSTRACT

Computer-based method and system for geo-spatial analysis are disclosed herein. The method and system facilitate a user, without any hard knowledge of geographic information system (GIS) to perform quick geo-spatial analysis with a fully automated, single step, and single input process including automatically retrieving a first set of satellite images corresponding to a geographic area and a first time frame provided by the user, automatically processing the first set of satellite images to determine first values of one or more urban parameters corresponding to the geographic area for the first time frame, and automatically presenting a visualization depicting the first values of the one or more urban parameters.

### FIELD OF THE INVENTION

Embodiments described herein in general, concern computer-based method and system for geo-spatial analysis. More particularly, the embodiments concern to a fully automated geospatial artificial intelligence (Geo-AI) based method and system for determining and presenting quantitative analysis of urban parameters.

### CROSS-REFERENCES

Various methods, systems, apparatus, and technical details relating to the present invention are disclosed in the following co-pending applications filed by the applicant or assignee of the present invention. The disclosures of all of these co-pending/granted applications are incorporated herein by cross-reference.
Co-pending application titled “COMPUTER-BASED METHOD AND SYSTEM FOR URBAN PLANNING.”
Co-pending application titled “COMPUTER-BASED METHOD AND SYSTEM FOR DETERMINING GROUNDWATER POTENTIAL ZONES.”
Co-pending application titled “COMPUTER-BASED METHOD AND SYSTEM FOR PREDICTING AND GENERATING LAND USE LAND COVER (LULC) CLASSIFICATION.”

### BACKGROUND OF THE INVENTION

Unless otherwise indicated herein, the approaches described in this section are not prior art to the claims in this application and are not admitted to be prior art by inclusion in this section.

Urban parameters including surface and environmental parameters are required in various applications of urban planning and management. Urban parameters allow for diagnosis of problems and pressure on cities, and help in identification of areas that would profit from being addressed through good governance and science-based responses allowing cities to monitor and manage the resources and success and impact of sustainability interventions. Nowadays, Geospatial Technology and Earth Observation System play a vital role in monitoring the urban parameters for efficient planning and development.

The data provided by the earth observation system usually includes large sized satellite image files and is often provided in a format which requires more resources to store and process than necessary.

Also, the conventional computer-based systems for monitoring the urban parameters are not fully automatic and a user must have good knowledge of geographic information system (GIS) for operating the conventional computer-based systems.

Hence, it is apparent that a need exists for a Geo-spatial artificial intelligence (Geo-AI) based fully automated computer-based method and system for efficient data acquisition and processing for determining and presenting the urban parameters which empowers the user with enhanced visibility into data and where the user does not require any priori knowledge of the geographic information system (GIS) for operating the computer-based system.

### SUMMARY OF THE INVENTION

According to an embodiment, a computer-implemented method for geo-spatial analysis is described. The computer-implemented method comprises receiving a first input defining a geographic area and a first time frame. The computer-implemented method further comprises automatically retrieving a first set of satellite images corresponding to the geographic area and the first time frame, automatically processing the first set of satellite images to determine first values of one or more urban parameters corresponding to the geographic area for the first time frame, and automatically presenting a visualization depicting the first values of the one or more urban parameters.

According to an example, the one or more urban parameters may include at least one of a surface parameter and an environmental parameter.

According to an example, the surface parameter may include at least one of vegetation cover, surface water cover, built up area, vegetation moisture level, crop land cover, fallow land cover, and barren land.

According to an example, the environmental parameter may include at least one of land surface temperature, urban heat island effect, urban sprawl, and groundwater potential zone cover.

According to an example, automatically retrieving a first set of satellite images may include automatically selecting and retrieving satellite images with at most 5 percent cloud coverage from one or more servers.

According to an example, automatically retrieving a first set of satellite images may include automatically retrieving level-1 precision and terrain (L1TP) corrected satellite images from one or more servers.

According to an example, automatically processing the first set of satellite images to determine first values of one or more urban parameters may include automatically converting digital numbers of each pixel of one or more spectral band images, corresponding to the first set of satellite images, into reflectance values of the respective spectral bands using radiometric calibration. The computer-implemented method may further include automatically computing one or more spectral indices, corresponding to the one or more urban parameters, for each pixel of the first set of satellite images using the corresponding reflectance values.

According to an example, automatically retrieving a first set of satellite images may include automatically retrieving one or more spectral bands or images corresponding to the one or more urban parameters.

According to an example, automatically processing the first set of satellite images to determine first values of one or more urban parameters may include automatically fetching one or more spectral band images, corresponding to the one or more urban parameters, from the first set of satellite images.

According to an example, the one or more spectral indices may include at least one of normalized difference vegetation index (NDVI), modified normalized difference water index (MNDWI), index based built up index (IBI), normalized difference built up index (NDBI), normalized difference moisture index (NDMI), optimized soil adjusted vegetation index (OSAVI), and barren land index (BLI).

According to an example, the one or more urban parameters may include the one or more surface parameters and the computer-implemented method may further comprise automatically comparing each of the one or more spectral indices, for each pixel of the first set of satellite images, with a respective predefined threshold, and automatically classifying each pixel of the first set of satellite images, with respect to each of the one or more spectral indices, based on the respective comparison.

According to an example, automatically presenting a visualization depicting the first values of the one or more urban parameters may include automatically presenting the classified pixels, and respective classification, on an image of the geographic area.

According to an example, the computer-implemented method may further comprise automatically calculating a quantitative value of an area covered by pixels of each class, and automatically presenting the area covered by the pixels of each class on an image of the geographic area.

According to an example, the environmental parameter may include the land surface temperature, and the one or more spectral indices may include the NDVI, and the computer-implemented method may further comprise automatically computing surface emissivity for each pixel of the first set of satellite images using the respective NDVI. The computer-implemented method may further comprise automatically converting digital numbers of each pixel of one or more thermal infrared spectral band images, corresponding to the first set of satellite images, into radiance values of respective thermal infrared spectral bands, automatically converting the radiance values of each pixel of the first set of satellite images to respective satellite brightness temperature. The computer-implemented method may further comprise automatically computing the land surface temperature for each pixel of the first set of satellite images using the respective satellite brightness temperature and the respective surface emissivity, and automatically presenting the land surface temperature for each pixel on an image of the geographic area.

According to an example, the environmental parameter may include the urban heat island effect and the computer-implemented method may further comprise automatically normalizing the land surface temperature values for each pixel of the first set of satellite images, automatically comparing each of the normalized land surface temperature values with a predefined threshold, and automatically classifying each pixel of the first set of satellite images, with respect to the normalized land surface temperature values, based on the respective comparison. The computer-implemented method may further comprise automatically presenting the classified pixels, and respective classification, on an image of the geographic area.

According to an example, automatically presenting a visualization depicting the first values of the one or more urban parameters may include automatically presenting grid wise information of the land surface temperature on an image of the geographic area.

According to an example, the environmental parameter may include the urban sprawl, the surface parameter may include the built up area, and the one or more spectral indices may include IBI, and the computer-implemented method may further comprise automatically computing shannon's entropy for the geographic area using the built up area, and automatically determining the urban sprawl corresponding to the the geographic area, based on the shannon's entropy. The computer-implemented method may further comprise automatically presenting the urban sprawl on an image of the geographic area.

According to an example, the environmental parameter may include the groundwater potential zone cover and the one or more spectral indices may include the NDVI, MNDWI, NDBI, and NDMI, and the computer-implemented method may further comprise automatically retrieving slope data of the geographic area from Shuttle Radar Topography Mission (SRTM) Digital elevation model, and automatically computing the ground water potential zone cover via analytic hierarchy process (AHP) and weighted sum approach using the NDVI, MNDWI, NDBI, NDMI, and the slope data. The computer-implemented may further comprise automatically presenting the ground water potential zone cover on an image of the geographic area.

According to an example, the first set of satellite images may include Moderate Resolution Imaging Spectroradiometer (MODIS) satellite images and the one or more urban parameters may include particulate matter (PM) concentration, and the computer-implemented method may further comprise automatically retrieving aerosol optical depth (AOD) product from the MODIS satellite images, automatically retrieving ground-based PM concentration data, and meteorological data. The computer implemented method may further comprise automatically computing the PM concentration from the AOD product, the ground-based PM concentration data, and the meteorological data using linear regression model. The computer implemented method may further comprise automatically presenting the particulate matter (PM) concentration on an image of the geographic area.

According to an example, the computer-implemented method may further comprise receiving a second input defining a second time frame, automatically retrieving a second set of satellite images corresponding to the geographic area and the second time frame, automatically processing the second set of satellite images to determine second values of the one or more urban parameters corresponding to the geographic area for the second time frame. The computer-implemented method may further comprise automatically presenting a visualization depicting a comparison of the first and the second values of the one or more urban parameters, the comparison illustrating a quantitative relative change in the one or more urban parameters corresponding to the geographic area over a time duration from the first time frame to the second time frame.

According to another exemplary embodiment, a system for geo-spatial analysis is described. The system comprises at least one processor and at least one computer readable memory coupled to the at least one processor, and the processor is configured to perform all or some steps of the method described above.

According to another exemplary embodiment, a non-transitory computer readable medium is described. The non-transitory computer readable medium comprises a computer-readable code comprising instructions, which when executed by a processor, causes the processor to perform all or some steps of the method described above.

It is an object of the invention to provide a fully automated computer based method and system therefor for data acquisition and quantitative assessment of the urban parameters where a user does not require any hard knowledge of the geographic information system (GIS) for operating the computer-based system or method. The object is to provide a fully automated computer based method and a system therefor to enable a user to perform Geo-spatial analysis with minimum input (for example, only the ones related to geographic area and the time frame for which analysis is to be performed) and arriving directly at the quantitative assessment of various urban parameters related to the geographic area, and that too without the need for the user to have any hard knowledge of the GIS.

It is an object of the invention to link data science with geo-spatial domain knowledge to enable a user with no hard knowledge of GIS to perform the analysis with a single step process.

It is an object of the invention to provide a single input/step process to run the computer-based system or method to arrive at the quantitative analysis about the urban parameters.

It is an object of the invention to automatically provide quantitative statistical measurements of the urban parameters with better visualization depicting the change in various parameters over time within seconds and with a single click. The visualizations facilitate easily interpretable outcomes with granularity.

It is an object of the invention to automatically provide quantitative absolute and relative change in the urban parameters over a period of time thereby facilitating mapping and monitoring of urban dynamism by a user with minimal GIS knowledge.

It is an object of the invention to provide time efficiency. It is further an object of the invention to provide readable outputs of the urban parameters in most time and energy efficient manner.

It is an object of the invention to provide reduced memory consumption. The image pre-processing for retrieving the set of images from the one or more servers is performed on the one or more servers. The images do not need to be saved for analytical assessments while selecting the spectral bands. The process incurred in the analytics is on cloud.

The summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an exemplary flow diagram for an automated method for geospatial analysis for determining and presenting the urban parameters;

FIG. 1(a) shows the vegetation cover on an image of the geographic area;

FIG. 1(b) shows the surface water on an image of the geographic area;

FIG. 1(c) shows the built-up area on an image of the geographic area;

FIG. 1(d) shows the vegetation moisture level on an image of the geographic area;

FIG. 1(e) shows the crop land cover and fallow land cover on an image of the geographic area;

FIG. 1(f) shows the barren land on an image of the geographic area;

FIG. 2 schematically shows an exemplary flow diagram for an automated method for geospatial analysis for determining and presenting the land surface temperature (LST) and the urban heat island effect (UHI);

FIG. 2(a) shows the LST values for each pixel on an image of the defined geographic area;

FIG. 2(b) shows the grid wise information of the LST on an image of the geographic area for the defined time frame;

FIG. 2(c) shows the UHI areas and no UHI areas on an image of the geographic area;

FIG. 3 schematically shows an exemplary flow diagram for an automated method for geospatial analysis for determining and presenting the Urban Sprawl;

FIG. 3(a) shows the urban sprawl and shannon's entropy on an image of the geographic area;

FIG. 4 schematically shows an exemplary flow diagram for an automated method for geospatial analysis for determining and presenting the Groundwater potential zones;

FIG. 4(a) shows the ground water potential zones and corresponding classification on an image of the geographic area;

FIG. 5 schematically shows an exemplary flow diagram for an automated method for geospatial analysis for determining and presenting the particulate matter (PM) concentration;

FIG. 5(a) shows the PM concentration values on an image of the geographic area;

FIG. 6 schematically shows an exemplary flow diagram for detecting change in urban parameters over different time frames;

FIG. 6(a) shows the vegetation cover for the first time frame and the second time frame over the defined geographic area;

FIG. 6(b) shows the change map of the vegetation cover between the first time frame and second time frame; and

FIG. 7 schematically shows a block diagram of an illustrative example of a system for geospatial analysis for determining and presenting urban parameters

### GENERAL DESCRIPTION OF THE INVENTION

Urban parameters allow for diagnosis of problems and pressure on cities which is useful for development and planning to achieve the sustainable urban infrastructure. Urbanization is integrally connected to three pillars of sustainable development named as social, economic and environmental protection. The urban parameters include surface parameters and environmental parameters. The surface parameters represent surface characteristics of the earth like vegetation cover, surface water cover, crop land, barren land, moisture content of plants etc. The environmental parameters are used to analyze the environmental conditions using various surface characteristics of the earth for example land surface temperature, ground-water potential zones, air quality etc. Determining urban parameters help in identification of areas that would profit from being addressed through good governance and science-based responses allowing cities to monitor and manage the resources and success and impact of sustainability interventions.

Embodiments described herein generally concern to a fully automated computer-based system and method for geo-spatial analysis for determining and presenting the urban parameters corresponding to a geographic area.

Geospatial Technology and Earth Observation (EO) satellite play a vital role in determining the urban parameters for efficient planning and development.

For the purposes of the present description, the landsat and MODIS satellite images have been used for the purposes of the described methods and systems. However, such usage of specific satellite images be not considered as, in any way, limiting the scope of the present description. Any other satellite mission data, as would be known to a person having ordinary skill in the art, may be considered within the spirit and scope of the present description.

The Landsat 8 satellite payload consists of two science instruments—the Operational Land Imager (OLI) and the Thermal Infrared Sensor (TIRS). These two sensors provide seasonal coverage of the global landmass at a spatial resolution of 30 meters for coastal, visible (visible blue, visible green and visible red band), near infrared (NIR), and short wave infrared spectral bands (SWIR-1 and SWIR-2); 100 meters for thermal infrared (TIR) spectral bands; and 15 meters for panchromatic band. The image acquired by landsat 8 is a multi-spectral image consisting of 11 spectral bands.

The landsat 8 satellite acquires high-quality, well-calibrated multispectral data over the Earth's land surfaces. On average, over 650 unique images are acquired per day across the globe and sent to the USGS (United States Geological Survey) EROS (Earth Resources Observation and Science) Center for storage, archive, and processing. All of these images are processed to a standard Level-1 product.

Landsat scenes with the highest available data quality are placed into Tier 1 and are considered suitable for time-series analysis. Tier 1 includes Level-1 Precision and Terrain (L1TP) corrected data that have well-characterized radiometry and are inter-calibrated across the different Landsat instruments. The level-1 product data is radiometrically calibrated and orthorectified using ground control points (GCPs) and digital elevation model (DEM) data to correct for relief displacement. The highest quality Level-1 products are suitable for pixel-level time series analysis.

A complete standard Level-1 product consists of 13 files, including the 11 spectral band (OLI Bands 1-9 and TIR Bands 10 & 11) images, product-specific metadata file, and a Quality Assessment (QA) image. The image files are all 16-bit GeoTIFF images (a standard, public-domain image format based on Adobe's TIFF), which is a self-describing format developed to exchange raster images.

In addition to GeoTIFF, the data incorporate cubic convolution resampling, North Up (Map) image orientation, and Universal Transverse Mercator (UTM) map projection (Polar Stereographic projection for scenes with a center latitude greater than or equal to −63.0 degrees) using the WGS84 datum. The format of the final output product is a tar.gz file. The images are stored as tiled Geotiffs.

Google Earth Engine and the Amazon-NASA Earth Exchange (NEX) stores historical Landsat and MODIS data in a cloud based storage.

The urban parameters are determined by computing various spectral indices using the landsat-8 satellite images. The landsat-8 satellite image is a multi-spectral image that consists of 11 spectral bands. Spectral indices are combinations of spectral reflectance values from the two or more spectral bands that indicate the relative abundance of the urban parameters of interest.

### DETAILED DESCRIPTION OF THE INVENTION

Embodiments of the present invention are best understood by reference to the figures and description set forth herein. All the aspects of the embodiments described herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit and scope thereof, and the embodiments herein include all such modifications.

This description is generally drawn, inter alia, to methods, apparatuses, systems, devices, non-transitory mediums, and computer program products implemented as automated tools for geospatial analysis for determining and presenting quantitative analysis of urban parameters.

The description strives to revolutionize the concept of automatically determining and presenting quantitative analysis of urban parameters using the satellite images.

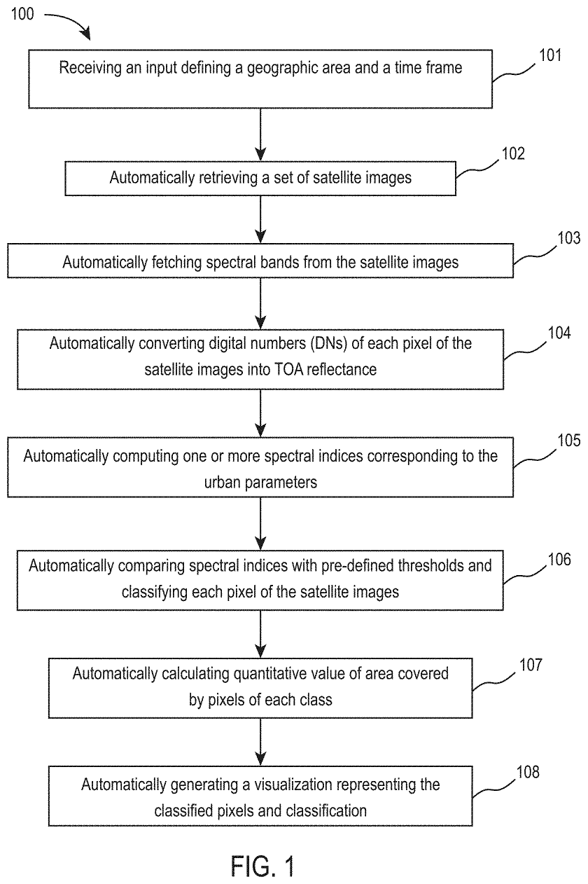

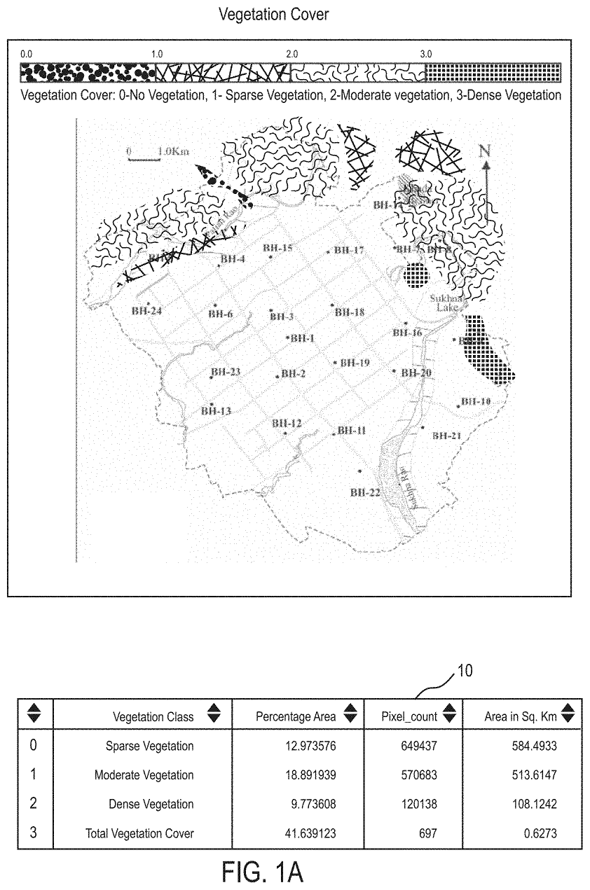

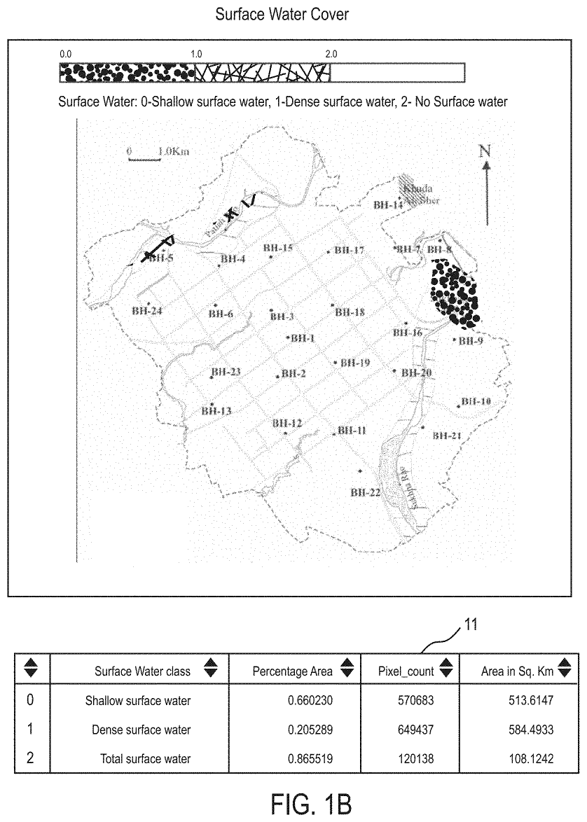

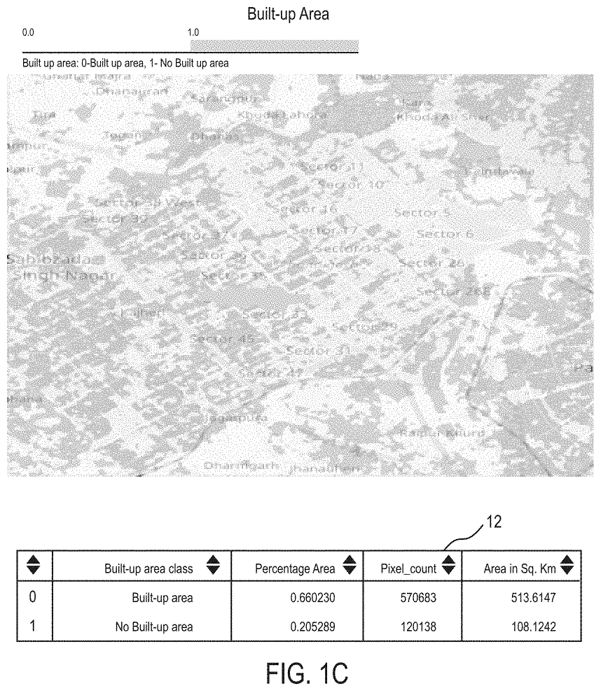

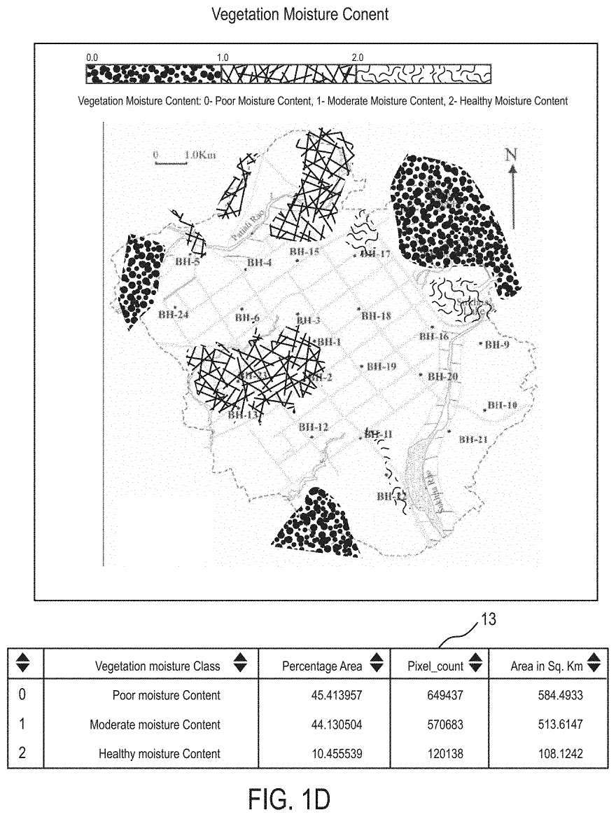

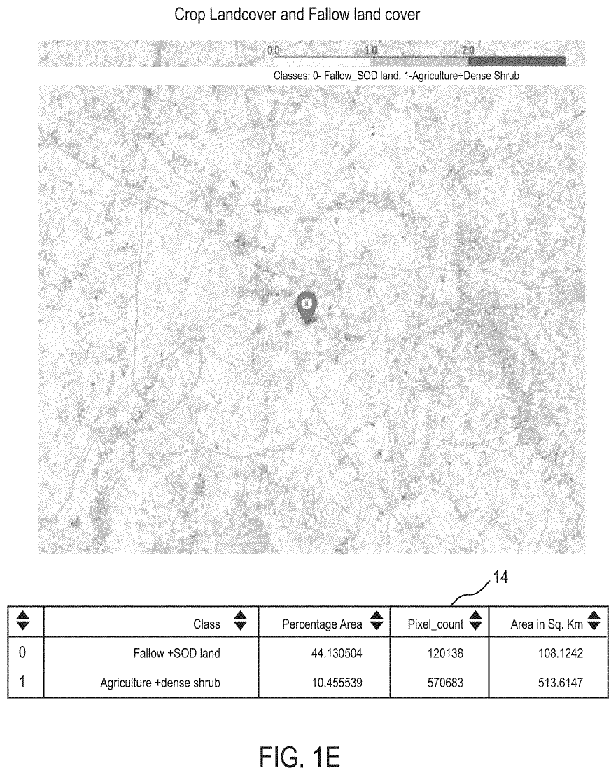

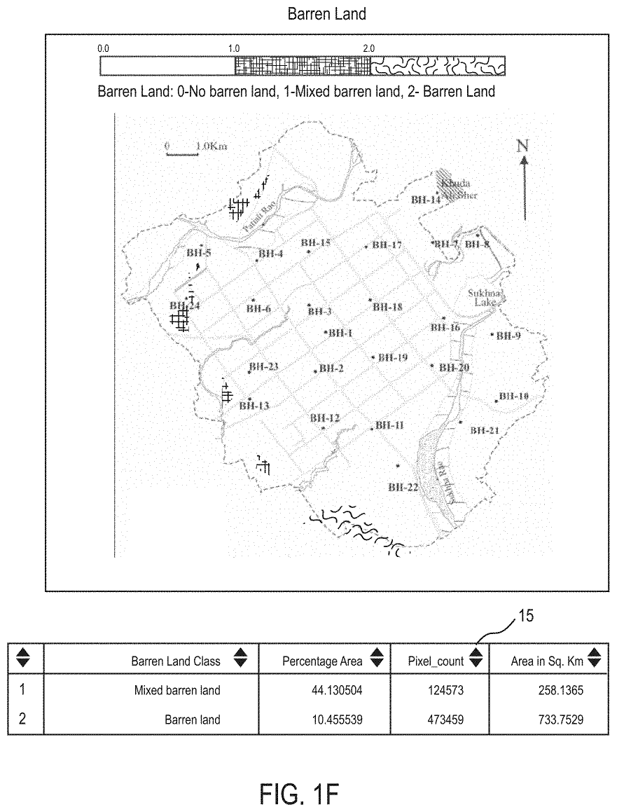

FIG. 1 schematically shows an exemplary flow diagram for an automated method for geospatial analysis for determining and presenting the urban parameters, in accordance with at least some embodiments described herein.

At step 101, an input defining a geographic area and a time frame is received from a user, the input intends towards analysis of urban parameters of the defined geographic area for the defined time frame. In some examples, the urban parameters may include but not limited to, at least one of the surface parameters and/or the environmental parameters. In some examples, the surface parameters may include but not limited to, at least one of vegetation cover, surface water cover, built up area, vegetation moisture level, crop land cover, fallow land cover, and barren land. In some examples, the environmental parameter may include but not limited to, at least one of land surface temperature, urban heat island effect, urban sprawl, and groundwater potential zone. In some examples, the input defining a geographic area may include but not limited to, an extent of a city, a city name, a latitude and/or longitude or any other geographic coordinates of an area. In some examples, the time frame may include but not limited to, a calendar year, a calendar date or a month. In some examples, the time frame may include a date range where the user provides a start date and an end date.

One skilled in the art will appreciate that two inputs with regard to geographic area and time frame has been described for the purpose of illustrations and not limitation. Any number of inputs with regard to geographic area and time frame throughout the methods described herein shall be considered within the spirit and scope of the present description.

Image Acquisition

At step 102, a set of satellite images corresponding to the defined geographic area and the time frame are automatically selected and retrieved from one or more servers. In some examples, landsat-8 satellite images are retrieved from the one or more servers. In some examples, the one or more servers may include but not limited to, Google Cloud Storage, Amazon AWS S3 or USGS EROS (Earth Resources Observation and Science) database, remote database, or a local database.

In some examples, the latitude and/or longitude values of the defined geographic area are converted into pixel locations. In some examples, the satellite images are stored in tiled form on the one or more servers. The satellite images are divided into multiple tiles in UTM/WGS84 projection. Each tile has its own projection information which is used for conversion of a spherical surface to a square tile and vice versa. In some examples, a separate list of all the projection information of all the tiles is automatically created that is used for converting the latitude and/or longitude values into pixel locations.

In some examples, the tile containing the defined geographic area corresponding to the defined time frame is automatically selected and retrieved from the one or more servers. In some examples, the defined geographic area lie around tile edges and fall on multiple tiles. In such a scenario, the best tile is selected and retrieved from the one or more servers to maintain the uniformity. In some examples, the multiple tiles containing the defined geographic area are merged together and the merged tiles are retrieved from the one or more servers for further processing.

In some examples, a set of satellite images corresponding to the defined geographic area and the time frame are automatically selected and bounding box containing the defined geographic area within the satellite images is automatically computed. The image is cropped around the edges of the bounding box and the cropped image is automatically retrieved from the one or more servers.

In some examples, the bounding box falling under the UTM zones corresponding to the defined geographic area are automatically selected and corresponding tiles are automatically retrieved from the one or more servers.

In some examples, the size of the tiles of the satellite images is very large usually in mega-bytes (MB). In such a scenario, the raster data of the satellite images is optimized by converting the raster data into a format that is handled by using standard Python libraries.

In some examples, the landsat level-1 product data corresponding to the defined geographic area and the time frame are automatically retrieved from the one or more servers. In some examples, geometrically corrected satellite images corresponding to the defined geographic area and time frame are automatically retrieved from the one or more servers. In some examples, the landsat level-1 Precision and Terrain (L1TP) corrected product data corresponding to the defined geographic area and the time frame are automatically retrieved from the one or more servers. The level-1 Precision and Terrain (L1TP) corrected product data is radiometrically calibrated and orthorectified using ground control points (GCPs) and digital elevation model (DEM) data to correct for relief displacement. The highest quality landsat level-1 products are suitable for pixel-level time series analysis.

In some examples, the satellite images having less cloud coverage are automatically selected and retrieved from the one or more servers. Cloud cover may obscure the ground underneath it and affects the satellite images which hampers the analysis results. In some examples cloud cover may include but not limited to clouds, atmospheric obstructions, such as smoke, snow, haze, or smog, or combinations thereof. In some examples, cloud based filters are used to automatically select those satellite images which have less cloud coverage. In some examples, only those satellite images which have less cloud coverage are automatically selected and retrieved from the one or more servers. In some examples, best satellite images with at most 5 percent cloud coverage corresponding to the defined geographic area and the time frame are automatically selected and retrieved from the one or more servers. In some examples, best satellite images with at most 7 percent, at most 10 percent, at most 15 percent, at most 20 percent, at most 25 percent, at most 30 percent, at most 35, or at most 40 percent cloud coverage corresponding to the defined geographic area and the time frame are automatically selected and retrieved from the one or more servers.

In some examples, cloud free satellite images are automatically selected and retrieved from the one or more servers.

In some examples, the one or more spectral bands or spectral band images corresponding to the defined geographic area, that are required for computing the spectral indices corresponding to the urban parameters, are automatically selected and retrieved from the one or more servers. In some examples, only those spectral bands of the satellite images corresponding to defined geographic area and time frame, that are required for computing the specific spectral indices corresponding to the specific urban parameters to be determined, are automatically selected and retrieved from the one or more servers. In some examples, spectral band specific satellite images corresponding to the defined geographic area and the time frame, that are required for computing the spectral indices corresponding to the urban parameters, are automatically selected and retrieved from the one or more servers.

In some examples, the image pre-processing for retrieving the set of images from the one or more servers is performed on the one or more servers. The images do not need to be saved for analytical assessments while selecting the spectral bands. The process incurred in the analytics is on cloud.

At step 103, the spectral bands or spectral band images corresponding to the urban parameter to be determined are automatically selected and fetched from the retrieved set of satellite images. In some examples, the spectral band specific satellite images that are required for determining the urban parameter are automatically selected and fetched from the retrieved set of satellite images.

Image processing

At step 104, digital numbers (DN) of each pixel of one or more spectral bands or spectral band images, corresponding to the set of satellite images, are automatically converted into reflectance values of the respective spectral bands. Each landsat satellite image consists of 11 spectral bands. Each pixel intensity in each spectral band of the satellite image is coded using a digital number in specific bit ranges. The raw digital number of each pixel of the satellite image in each spectral band is converted into reflectance value of the respective spectral band. In some examples, the reflectance value includes Top of Atmosphere (ToA) reflectance value. In some examples, radiometric calibration is used to convert the digital numbers of each pixel of the satellite images into reflectance values. The radiometric calibration converts the digital number of each pixel of the satellite image in each spectral band into TOA reflectance value of the respective spectral band using the band-specific calibration coefficients provided in the product-specific metadata file of the level 1 product data of the lands at. The digital numbers of each pixel of the satellite images provided in the Level 1 product data are converted to TOA reflectance values using the following equation:

ρ λ=(M ρ*Q cal+A ρ)/cos(θ SZ); where
ρ λ=TOA Reflectance;
M ρ=Reflectance multiplicative scaling factor for the band (REFLECTANCEW_MULT_BAND_n from the metadata);
A ρ=Reflectance additive scaling factor for the band; (REFLECTANCE_ADD_BAND_N from the metadata);
Q cal=Level 1 pixel value in DN;
θ SE=Local sun elevation angle; the scene center sun elevation angle in degrees is provided in the metadata;
θ SZ=Local solar zenith angle; θSZ=90°−θSE.

In some examples, the digital numbers (DN) of each pixel of one or more spectral bands or spectral band images, corresponding to the set of satellite images, are automatically converted into radiance values of the respective spectral bands. The raw digital number of each pixel of the satellite image in each spectral band is converted into radiance value of the respective spectral band. The radiometric calibration is used to convert the digital number of each pixel of the satellite image in each spectral band into radiance value of the respective spectral band using the band-specific calibration coefficients provided in the product-specific metadata file of the level 1 product data of the satellite images using the following equation:

Lλ=ML*Q cal+AL; where:

Lλ=Spectral radiance(W/(m²*sr*μm));
ML=Radiance multiplicative scaling factor for the band; (RADIANCE_MULT_BAND_n from the metadata);
AL=Radiance additive scaling factor for the band; (RADIANCE_ADD_BAND_n from the metadata);
Q cal=Level 1 pixel value in DN.

At step 105, spectral indices corresponding to the urban parameter to be determined are automatically computed for each pixel of the satellite images using the corresponding spectral band specific reflectance values. The spectral indices are used to determine the urban parameters. In some examples, spectral indices corresponding to the urban parameter to be determined are automatically computed for each pixel of the satellite images using the corresponding reflectance values of one or more spectral bands.

In some examples, the spectral indices may include but not limited to normalized difference vegetation index (NDVI), modified normalized difference water index (MNDWI), index based built up index (IBI), normalized difference built up index (NDBI), normalized difference moisture index (NDMI), optimized soil adjusted vegetation index (OSAVI), and barren land index (BLI).

At step 106, the spectral indices for each pixel of the satellite images are automatically compared with respective pre-defined thresholds. Based on the comparison, each pixel is then automatically classified into one or more classes with respect to each of the spectral index representing the corresponding surface parameter. In some examples, a set of default threshold values are generalized for each spectral index to classify each pixel into one or more classes with respect to each of the spectral index.

At step 107, an area covered by pixels of each class is automatically calculated. In some examples, percentage of total geographic area covered by pixels of each class is calculated.

At step 108, a visualization depicting the classified pixels and the respective classification is automatically generated. In some examples, the classified pixels and the respective classification are presented on an image of the geographic area. In some examples, the classified pixels and the respective classification are presented on a map of the geographic area. In some examples, thematic maps or thematic layers representing the classified pixels and the respective classification of the corresponding spectral indices and the corresponding surface parameters are automatically generated. In some examples, a visualization depicting the quantitative value of the area and/or the percentage of geographic area covered by pixels of each class representing the respective urban parameter is automatically generated. In some examples, pixel count of each class is presented on an image or a map of the geographic area. In some examples, the quantitative value of the area and/or the percentage of geographic area covered by pixels of each class is presented on an image or a map of the geographic area. In some examples, the pixel count, and/or the quantitative value of the area and/or the percentage of geographic area covered by pixels of each class is presented in a readable output to the user. The readable output may include but not limited to, a text, a message or a tabular form.

In some examples, the surface parameter includes the vegetation cover. The vegetation cover provides the status of greenness over the defined geographic area for the defined time frame. The spectral index required for the determination of the vegetation cover includes the normalized difference vegetation index (NDVI). In such a scenario, the visible red and near-infrared (NIR) bands of the satellite images corresponding to the defined geographic area and the time frame are automatically retrieved from the one or more servers. The digital number of each pixel of the satellite image in the visible red band is converted into respective reflectance value of the visible red band. The digital number of each pixel of the satellite image in the NIR band is converted into respective reflectance value of the NIR band. The NDVI is computed for each pixel of the satellite images using the respective reflectance values of the visible red band and the NIR band.

NDVI=(NIR−RED)/(NIR+RED)

The NDVI value of each pixel of the satellite images is compared with pre-defined thresholds to classify each pixel of the satellite images into one of the three classes including but not limited to sparse vegetation cover, moderate vegetation cover, or dense vegetation cover. However, any other form of classification, as may be understood to a person skilled in the art may be used. The visualization depicting the classified pixels and the respective classification representing the vegetation cover on the defined geographic area for the defined time frame is automatically generated and presented to the user.

As an example, FIG. 1(a) shows the vegetation cover on an image of the defined geographic area for the defined time frame. As shown in FIG. 1(a), each pixel of the satellite image is classified into sparse vegetation cover, moderate vegetation cover, or dense vegetation cover. The table 10 presents the classification, pixel count of each class, the area in square km covered by each class, the percentage of total area covered by each class, and the total vegetation cover in the defined geographic area over the defined time frame.

In some examples, the surface parameter includes the surface water cover. The surface water cover represents the spatial coverage or extent of water filled areas like lakes, rivers etc. The spectral index required for the determination of the surface water cover includes the modified normalized difference water index (MNDWI). In such a scenario, the visible green and short wave infrared (SWIR) bands of the satellite images corresponding to the defined geographic area and the time frame are automatically retrieved from the one or more servers. The digital number of each pixel of the satellite image in the visible green band image is converted into reflectance value of the visible green band. The digital number of each pixel of the satellite image in the SWIR band image is converted into reflectance value of the SWIR band. The MNDWI is computed for each pixel of the satellite images using the respective reflectance values of the visible green band and the SWIR band.

MNDWI=(Green−SWIR)/(Green+SWIR)

The MNDWI value of each pixel of the satellite images is compared with pre-defined thresholds to classify each pixel of the satellite images into one of the two classes including but not limited to shallow water cover or dense water cover. However, any form of classification as may be understood to a person skilled in the art may be used.

As an example, FIG. 1(b) shows the surface water on an image of the defined geographic area for the defined time frame. As shown in FIG. 1(b), each pixel of the satellite image is classified into shallow water cover or dense water cover. The table 11 presents the classification, pixel count of each class, the area in square km covered by each class, the percentage of total area covered by each class, and total area covered by surface water in the defined geographic area over the defined time frame.

In some examples, the surface parameter includes the built-up area. The built up area provides the trend and pattern of built up area in the defined geographic area. The spectral index required for the determination of the built-up area includes the index based built up index (IBI). In such a scenario, the visible red, visible green, near-infrared (NIR) and short wave infrared (SWIR) bands of the satellite images corresponding to the defined geographic area and the time frame are automatically retrieved from the one or more servers. The digital number of each pixel of the satellite image in the visible red band image is converted into reflectance value of the visible red band. The digital number of each pixel of the satellite image in the visible green band image is converted into reflectance value of the visible green band. The digital number of each pixel of the satellite image in the NIR band image is converted into reflectance value of the NIR band. The digital number of each pixel of the satellite image in the SWIR band image is converted into reflectance value of the SWIR band. The IBI is computed for each pixel of the satellite images using the respective reflectance values of the visible red, visible green, NIR and SWIR band.

IBI=[{2 SWIR/(SWIR+NIR)−{(NIR/(NIR+Red))+(Green/(Green+SWIR))}]/[{2 SWIR/(SWIR+NIR)+{(NIR/(NIR+Red))+(Green/(Green+SWIR))}]

The IBI value of each pixel of the satellite images is compared with pre-defined thresholds to classify each pixel of the satellite images into one of the two classes including but not limited to covered built up or no built up. However, any form of classification as may be understood to a person skilled in the art may be used.

As an example, FIG. 1(c) shows the built-up area on an image of the defined geographic area for the defined time frame. As shown in FIG. 1(c), each pixel of the satellite image is classified into covered built up or no built up. The table 12 presents the classification, pixel count of each class, the area in square km covered by each class and the percentage of total area covered by each class.

In some examples, the surface parameter includes the vegetation moisture level. The vegetation moisture level represents the moisture content in vegetation and plant stress. The spectral index required for the determination of the vegetation moisture level includes the normalized difference moisture index (NDMI). In such a scenario, the near-infrared (NIR) and the short wave infrared (SWIR) bands of the satellite images corresponding to the defined geographic area and the time frame are automatically retrieved from the one or more servers. The digital number of each pixel of the satellite images in the NIR band is converted into reflectance value of the NIR band. The digital number of each pixel of the satellite image in the SWIR band is converted into reflectance value of the SWIR band. The NDMI is computed for each pixel of the satellite images using the respective reflectance values of the NIR and SWIR band.

NDMI=(NIR−SWIR)/(NIR+SWIR)

The NDMI value of each pixel of the satellite images is compared with pre-defined thresholds to classify each pixel of the satellite images into one of the three classes including but not limited to poor moisture level, moderate moisture level, or healthy moisture level. However, any form of classification as may be understood to a person skilled in the art may be used.

As an example, FIG. 1(d) shows the vegetation moisture level on an image of the defined geographic area for the defined time frame. As shown in FIG. 1(d), each pixel of the satellite image is classified into poor moisture level, moderate moisture level, or healthy moisture level. The table 13 presents the classification, pixel count of each class, the area in square km covered by each class and the percentage of total area covered by each class.

In some examples, the surface parameter includes the crop land cover or/and fallow land cover. The crop land cover or/and fallow land cover is used to determine the lands containing current farms, fallow lands, sod or/and turf grass fields. The spectral index required for the determination of the crop land cover or/and fallow land cover includes the optimized soil adjusted vegetation index (OSAVI). In such a scenario, the near-infrared (NIR) and the visible red bands of the satellite images corresponding to the defined geographic area and the time frame are automatically retrieved from the one or more servers. The digital number of each pixel of the satellite images in the NIR band is converted into reflectance value of the NIR band. The digital number of each pixel of the satellite image in the visible red band is converted into reflectance value of the visible red band. The OSAVI is computed for each pixel of the satellite images using the respective reflectance values of the NIR and visible red band.

OSAVI=(NIR−Red)/(NIR+Red+0.16)

The OSAVI value of each pixel of the satellite images is compared with pre-defined thresholds to classify each pixel of the satellite images into one of the three classes including but not limited to fallow+sod land or agriculture+dense land. However, any form of classification as may be understood to a person skilled in the art may be used.

As an example, FIG. 1(e) shows the crop land cover and fallow land cover on an image of the defined geographic area for the defined time frame. As shown in FIG. 1(e), each pixel of the satellite image is classified into fallow+sod land or agriculture+dense land. The table 14 presents the classification, pixel count of each class, the area in square km covered by each class and the percentage of total area covered by each class.

In some examples, the surface parameter includes the barren land. The spectral index required for the determination of the barren land includes the barren land index (BLI). In such a scenario, the visible green, the visible red and the near-infrared (NIR) bands of the satellite images corresponding to the defined geographic area and the time frame are automatically retrieved from the one or more servers. The digital number of each pixel of the satellite image in the visible green band is converted into reflectance value of the visible green band. The digital number of each pixel of the satellite image in the visible red band is converted into reflectance value of the visible red band. The digital number of each pixel of the satellite images in the NIR band is converted into reflectance value of the NIR band. The BLI is computed for each pixel of the satellite images using the respective reflectance values of the visible green, the visible red and the NIR band.

BLI=Green²+Red²+NIR²/60

The BLI value of each pixel of the satellite images is compared with pre-defined thresholds to classify each pixel of the satellite images into one of the two classes including but not limited to barren land or mixed barren land. However, any form of classification as may be understood to a person skilled in the art may be used.

As an example, FIG. 1(f) shows the barren land on an image of the defined geographic area for the defined time frame. As shown in FIG. 1(f), each pixel of the satellite image is classified into barren land or mixed barren land. The table 15 presents the classification, pixel count of each class, the area in square km covered by each class and the percentage of total area covered by each class.

In some examples, the spectral index includes the normalized difference built-up index (NDBI). In such a scenario, the near-infrared (NIR) and the short wave infrared (SWIR) bands of the satellite images corresponding to the defined geographic area and the time frame are automatically retrieved from the one or more servers. The digital number of each pixel of the satellite images in the NIR band is converted into reflectance value of the NIR band. The digital number of each pixel of the satellite image in the SWIR band is converted into reflectance value of the SWIR band. The NDMI is computed for each pixel of the satellite images using the respective reflectance values of the NIR and SWIR band.

NDBI=(SWIR−NIR)/(SWIR+NIR)

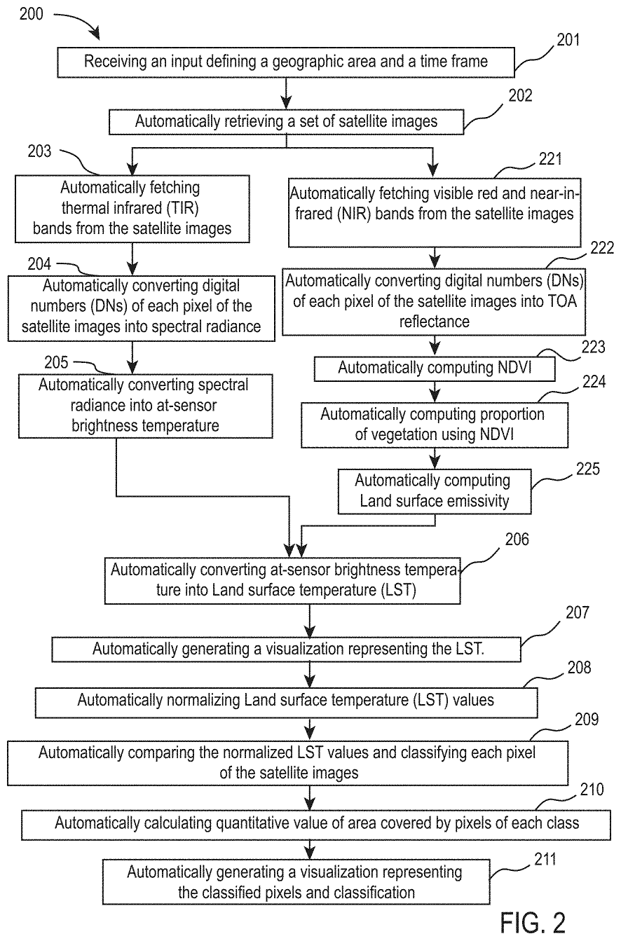

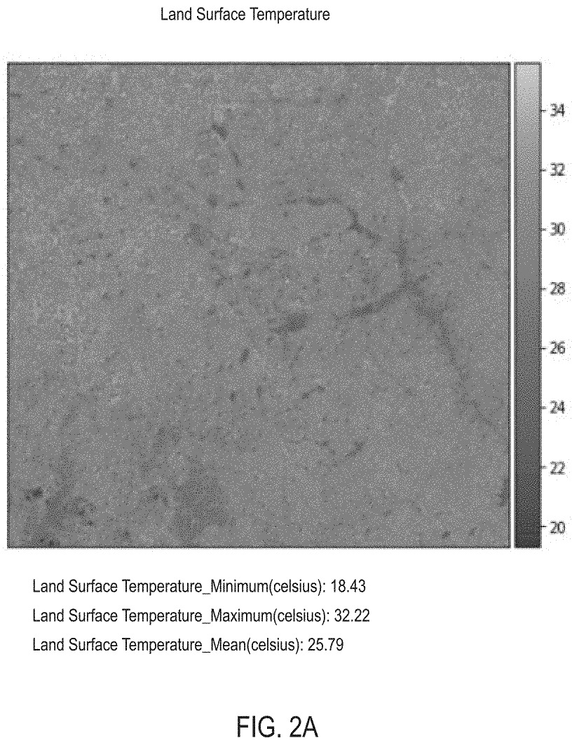

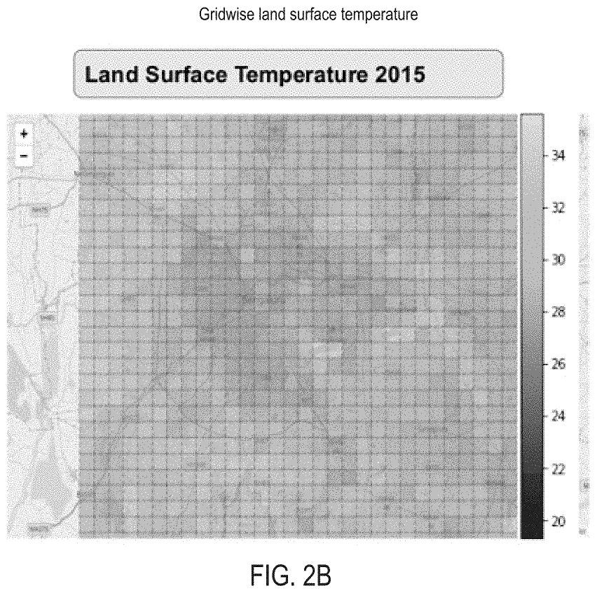

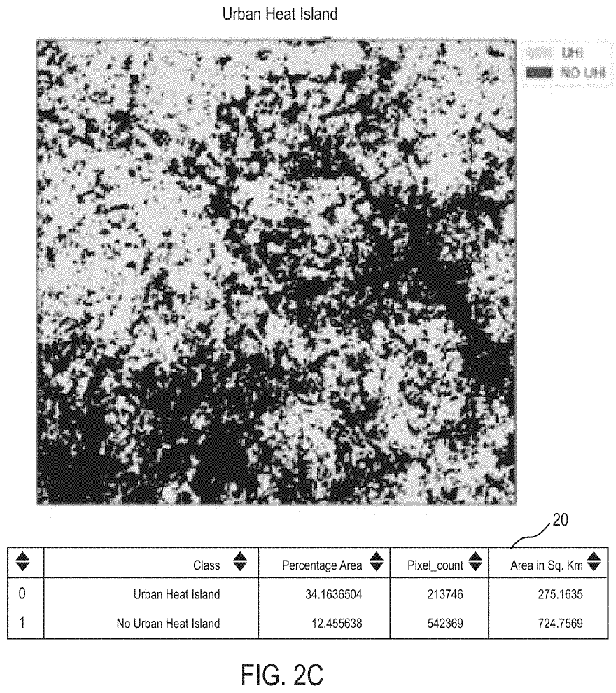

FIG. 2 schematically shows an exemplary flow diagram for an automated method 200 for geospatial analysis for determining and presenting the land surface temperature (LST) and the urban heat island effect (UHI).

The LST and UHI are the environmental parameters that represents the urban thermal environment. The thermal infrared (TIR) bands of the satellite images and land surface emissivity characteristics are used to determine the LST and UHI.

Steps 201 for receiving an input defining a geographic area and a time frame, and step 202 for automatically retrieving the satellite images corresponding to the defined geographic area and the time frame from one or more servers, are similar to steps 101 and 102, respectively, of method 100 of FIG. 1.

Image Processing

At step 203, the thermal infrared (TIR) bands are automatically fetched from the retrieved satellite images corresponding to the defined geographic area and time frame. In some examples, the thermal infrared (TIR) bands of the satellite images corresponding to the defined geographic area and time frame are automatically retrieved from the one or more servers.

At step 204, digital numbers (DN) of each pixel of one or more thermal infrared (TIR) spectral bands or TIR band images, corresponding to the set of satellite images, are converted into radiance values of respective thermal infrared spectral bands. The digital number of each pixel of the satellite images in each TIR bands is converted into spectral radiance value of the respective TIR band using the following equation:

Lλ=ML*Q cal+AL−Oi; where:

Lλ=Spectral radiance(W/(m²*sr*μm));
ML=Radiance multiplicative scaling factor for the band; (RADIANCE_MULT_BAND_n from the metadata);
AL=Radiance additive scaling factor for the band; (RADIANCE_ADD_BAND_n from the metadata);
Q cal=Level 1 pixel value in DN of the TIR band;
Oi=correction for the TIR band.

At step 205, the spectral radiance values of each pixel of the satellite images in each TIR band is converted to respective At-sensor brightness temperature using following equation:

BT=K2/ln[(K1/Lλ)+1]; where:
BT is effective At-sensor brightness temperature in Kelvin;
K1 and K2 stand for the band-specific thermal conversion constants from the metadata.

In some examples, the At-sensor brightness temperature is converted by adding the absolute zero (−273.15° C.) for obtaining the results in Celsius (° C.).

BT(° C.)=K2/ln[(K1 /Lλ)+1]−273.15

At step 206, the At-sensor brightness temperature of each pixel of the satellite images in each TIR band is converted to respective LST using following equation:

Ts=BT/{1+λ(BT/ρ)ln ελ}; where:
Ts is the LST in Celsius (° C.);
BT is the at-sensor brightness temperature in Celsius (° C.);
λ is the wavelength of emitted radiance;
ελ is the land surface emissivity;

Steps 221 to 225 of FIG. 2 illustrates an automated process for determining the land surface emissivity, ελ.

The land surface emissivity is computed using the NDVI. The visible red and near-infrared (NIR) bands of the satellite images are used to compute NDVI values. Steps 221 to 223 illustrates an automated process for determining the NDVI as illustrated in detail in one of the above examples of FIG. 1.

At step 224, proportion of vegetation is computed for each pixel of the satellite images using the respective NDVI values.

Pv=([NDVI−NDVIs])²/([NDVIv+NDVIs]); where:
Pv=proportion of vegetation;
NDVIs and NDVIv values are the thresholds of soil and vegetation pixels.

At step 225, the land surface emissivity is computed for each pixel of the satellite images using the respective proportion of vegetation (Pv).

At step 207, a visualization depicting the LST values for each pixel of the satellite images is generated. In some examples, the LST values for each pixel of the satellite images is presented on an image or a map of the defined geographic area for the defined time frame. In some examples, grid wise information of the LST is presented on an image or a map of the geographic area for the defined time frame. In some examples, the LST values are presented in a readable output to the user. The readable output may include but not limited to, a text, a message or a tabular form. In some examples, thematic maps or thematic layers representing the LST values are automatically generated.

As an example, FIG. 2(a) shows the LST values for each pixel on an image of the defined geographic area for the defined time frame. The minimum, maximum and mean LST values in defined geographic area are also presented to the user. FIG. 2(b) shows the grid wise information of the LST on an image of the geographic area for the defined time frame.

At step 208, the land surface temperature values of each pixel of the satellite images are normalized to evaluate the UHI.

UHI=(Ts−Tm)/SD; where: T s is the land surface temperature, T m is the mean of the land surface temperature of the study area, and SD is the standard deviation.

At step 209, the normalized LST value of each pixel of the satellite images is compared with pre-defined thresholds to classify each pixel of the satellite images into one of the two classes including but not limited to UHI or no UHI. However, any form of classification as may be understood to a person skilled in the art may be used.

At step 210, an area covered by pixels of each class is automatically calculated. In some examples, percentage of total geographic area covered by pixels of each class is calculated.

At step 211, a visualization depicting the classified pixels and the respective classification is generated and presented on an image or map of the geographic area. In some examples, thematic maps or thematic layers representing the classified pixels and the respective classification are automatically generated. In some examples, a visualization depicting the quantitative value of the area and/or the percentage of geographic area covered by pixels of each class is generated and presented on an image or map of the geographic area. In some examples, the pixel count, and/or the quantitative value of the area and/or the percentage of geographic area covered by pixels of each class is presented in a readable output to the user. The readable output may include but not limited to, a text, a message or a tabular form.

As an example, FIG. 2(c) shows the UHI areas and no UHI areas on an image of the defined geographic area for the defined time frame. As shown in FIG. 2(c), each pixel of the satellite image is classified into UHI or No UHI. The table 20 presents the classification, pixel count of each class, the area in square km covered by each class and the percentage of total area covered by each class.

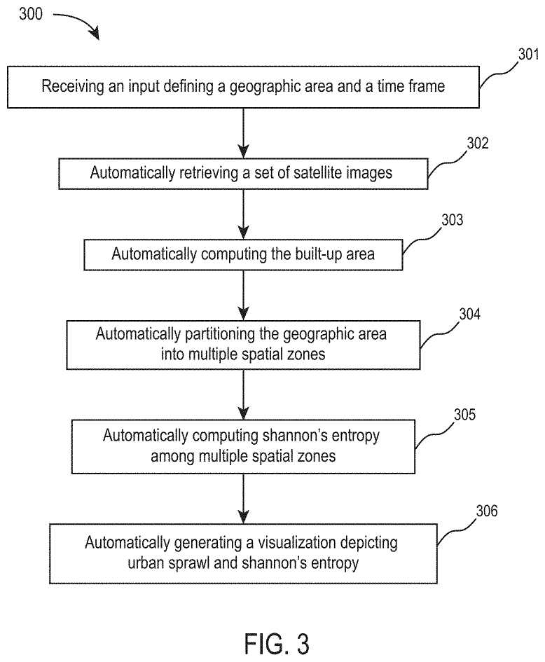

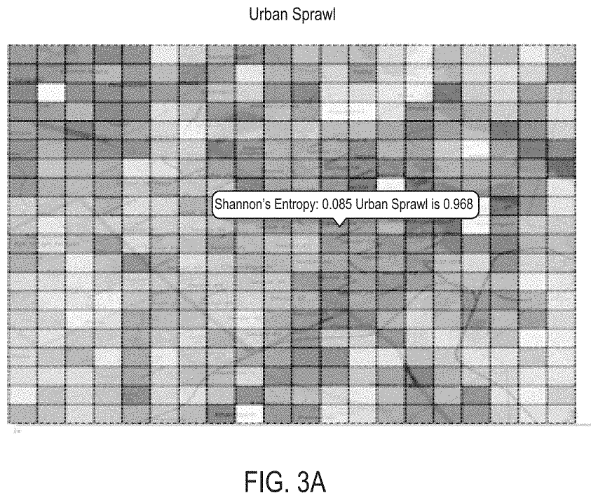

FIG. 3 schematically shows an exemplary flow diagram for an automated method 300 for geospatial analysis for determining and presenting the Urban Sprawl.

The Urban sprawl is used to determine urban growth on the defined geographic area over the defined time period. The urban sprawl represents the degree of spatial concentration or dispersion of the built-up area. Therefore, Urban Sprawl for the defined geographic area over the defined time period is determined by determining the built up area.

Step 301 for receiving an input defining a geographic area and a time frame, and step 302 for automatically retrieving the satellite images corresponding to the defined geographic area and the time frame from one or more servers, are similar to steps 101 and 102, respectively, of method 100 of FIG. 1.

At step 303, the built-up area for the defined geographic area over the defined time period is computed. The method for computing the built-up area is illustrated in one of the examples of FIG. 1.

At step 304, the defined geographic area is partitioned into multiple spatial zones.

At step 305, Shannon's entropy (Hn) is automatically computed which measures the degree of spatial concentration or dispersion of the built-up area among multiple spatial zones of the defined geographic area. Entropy is calculated by using the formula:

$${H}_{n} = - {\sum }_{i = 1}^{n} {p}_{i} {log}_{e} ( {p}_{i} )$$

where H n is the relative entropy, pᵢ is the probability of the built-up area being found in each of the i=1, . . . n zones of the defined geographic area.

Higher values of the shannon's entropy indicates the occurrence of the urban sprawl. A value of 0 indicates that distribution of the built-up area is very compact, while values closer to logₑ(n) reveal that the distribution of the built-up area is dispersed.

At step 306, a visualization depicting the urban sprawl and shannon's entropy value is generated and presented on an image of the geographic area for the defined time-frame. As an example, FIG. 3(a) shows the urban sprawl and shannon's entropy value on an image of the geographic area for the defined time-frame.

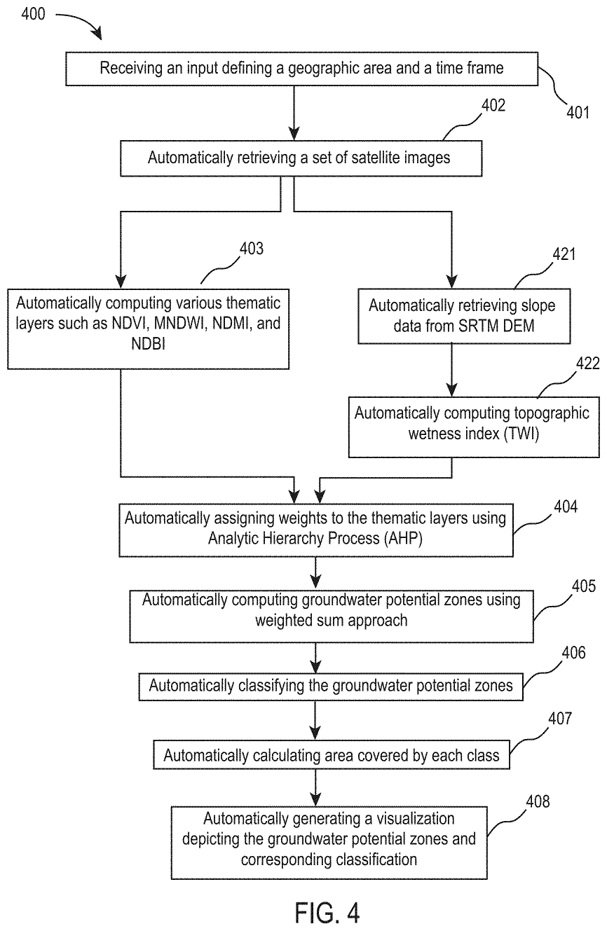

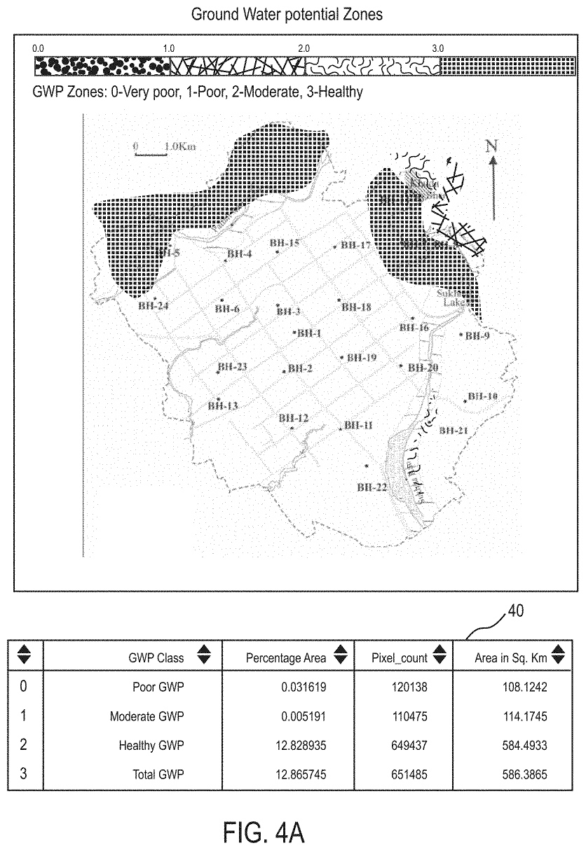

FIG. 4 schematically shows an exemplary flow diagram for an automated method 400 for geospatial analysis for determining and presenting the Groundwater potential zones.

Multiple thematic layers are used for determining the ground water potential zones. In some examples, the multiple thematic layers include the NDVI, MNDWI, NDMI, NDBI, and topographic wetness index (TWI).

Step 401 for receiving an input defining a geographic area and a time frame, and step 402 for automatically retrieving the satellite images corresponding to the defined geographic area and the time frame from one or more servers are, similar to steps 101 and 102, respectively, of method 100 of FIG. 1.

At step 403, various thematic layers such as NDVI, MNDWI, NDMI, and NDBI are computed. The methods for computing NDVI, MNDWI, NDMI, and NDBI are illustrated in examples of FIG. 1.

At step 421, the slope data corresponding to the defined geographic area and time frame is automatically derived from the SRTM DEM. In some examples, the slope data corresponding to the defined geographic area is automatically calculated using the SRTM DEM. In some examples, the SRTM DEM data is automatically retrieved from the one or more servers. In some examples, the slope data corresponding to the defined geographic area and time frame is automatically retrieved from the one or more servers.

At step 422, the topographic wetness index (TWI) is automatically computed. TWI is derived through interactions of fine-scale landform coupled to the up-gradient contributing land surface area according to the following equation:

TWI=ln[CA/Slope]; where CA is the local upslope catchment area that drains through a grid cell; and Slope is the steepest outward slope for each grid cell measured as drop/distance, i.e., tan of the slope angle.

At step 404, a weight is automatically assigned to each thematic layer including the NDVI, MNDWI, NDMI, NDBI, and the topographic wetness index using Analytic Hierarchy Process (AHP). In some examples, the weight for each thematic layer is automatically calculated using the AHP pair-wise comparison matrix. In some examples, the weight is assigned to each thematic layer by comparing each each thematic layer with respect to the other thematic layer. In some examples, a rank is automatically assigned to each class of the corresponding thematic layer according to their relevance with groundwater.

At step 405, all the thematic layers are integrated using weighted sum approach to compute groundwater potential zones.

At step 406, the determined ground water potential zones are classified into very poor GWP zones, poor GWP zones, moderate GWP zones, and healthy GWP zones based on comparison with predefined thresholds.

At step 407, an area covered by each class is automatically calculated. In some examples, percentage of total geographic area covered by each class is calculated.

At step 408, a visualization depicting the groundwater potential zones and corresponding classification is automatically generated and presented on an image or a map of the geographic area. In some examples, a visualization depicting the quantitative value of the area and/or the percentage of geographic area covered by each class is automatically generated. In some examples, the quantitative value of the area and/or the percentage of geographic area covered by each class is presented on an image or a map of the geographic area. In some examples, the quantitative value of the area and/or the percentage of geographic area covered by each class is presented in a readable output to the user. The readable output may include but not limited to, a text, a message or a tabular form.

As an example, FIG. 4(a) shows the ground water potential zones and corresponding classification on an image of the defined geographic area for the defined time frame. The table 40 presents the classification, pixel count of each class, the area in square km covered by each class, the percentage of total area covered by each class.

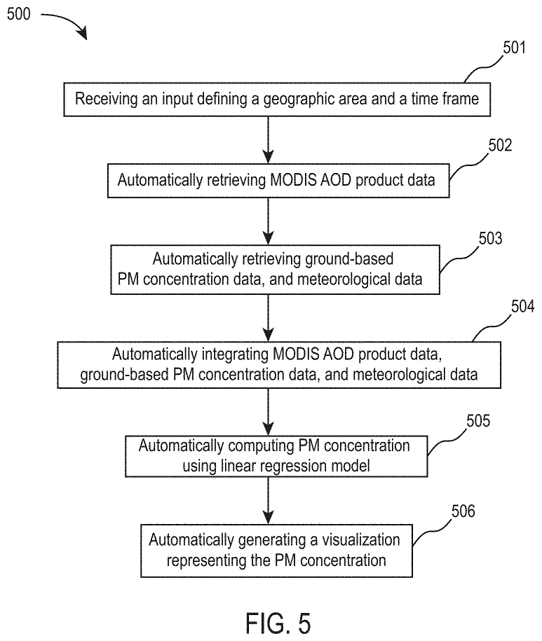

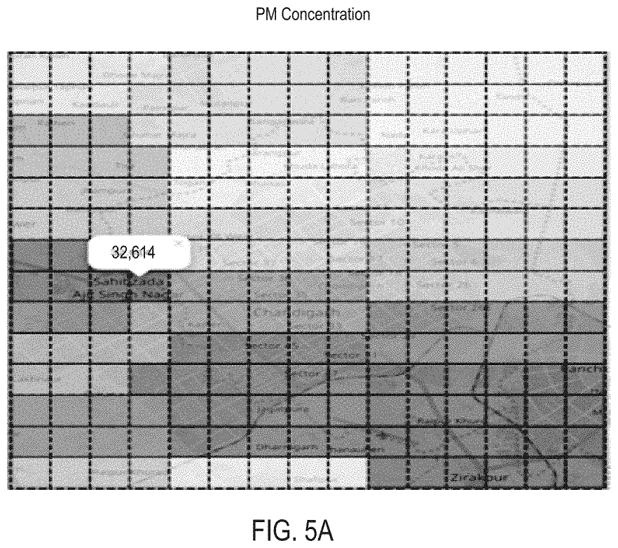

FIG. 5 schematically shows an exemplary flow diagram for an automated method 500 for geospatial analysis for determining and presenting the particulate matter (PM) concentration.

The particulate matter (PM) concentration represents the spatial coverage or extent of surface PM mass concentration in the defined geographic area for the defined time frame. In some examples, PM 2.5 concentration is determined. In some examples, ground-based measurements, meteorological and satellite data are integrated to determine PM concentrations. In some examples, the MODIS AQUA and TERA satellite images are used to determine the PM concentration.

At step 501, an input defining the extent of geographic area and time frame is received from the user, the input intended towards determination of PM concentration in the defined geographic area for the defined time frame. In some examples, the input defining a geographic area may include but not limited to, an extent of a city, a city name, a latitude and/or longitude or any other geographic coordinates of an area. In some examples, the time frame may include but not limited to, a calendar year, a calendar date or a month. In some examples, the time frame may include a date range where the user provides a start date and an end date.

At step 502, a set of satellite images corresponding to the defined geographic area and the time frame are automatically selected and retrieved from one or more servers. In some examples, the MODIS satellite images are retrieved from the one or more servers. In some examples, the one or more servers may include but not limited to, Google Cloud Storage, Amazon AWS S3 or USGS EROS (Earth Resources Observation and Science) database, remote database, or a local database. In some examples, MODIS aerosol optical depth (AOD) products corresponding to the defined geographic area and the time frame are automatically selected and retrieved from one or more servers. In some examples, step 502 for automatically retrieving the satellite images corresponding to the defined geographic area and the time frame from one or more servers, are similar to step 102 of method 100 of FIG. 1.

At step 503, ground-based PM concentration data, and meteorological data are automatically retrieved from the one or more servers. Various ground based stations are used to measure the PM concentration data. In some examples, the meteorological data includes but not limited to temperature, pressure, radiation, wind speed or humidity over the defined geographic area for the defined time frame.

At step 504, the MODIS AOD product, the ground based PM concentration data and the meteorological data are automatically integrated for PM concentration determination.

At step 505, the PM concentration is automatically computed from the AOD product, the ground-based PM concentration data, and the meteorological data using linear regression model. In some examples, multiple linear regression model is used for computing PM concentration. In some examples, two variable regression model is used for computing PM concentration.

At step 506, a visualization presenting the particulate matter (PM) concentration on an image of the geographic area is automatically generated.

As an example, FIG. 5(a) shows the PM concentration values on an image of the defined geographic area for the defined time frame.

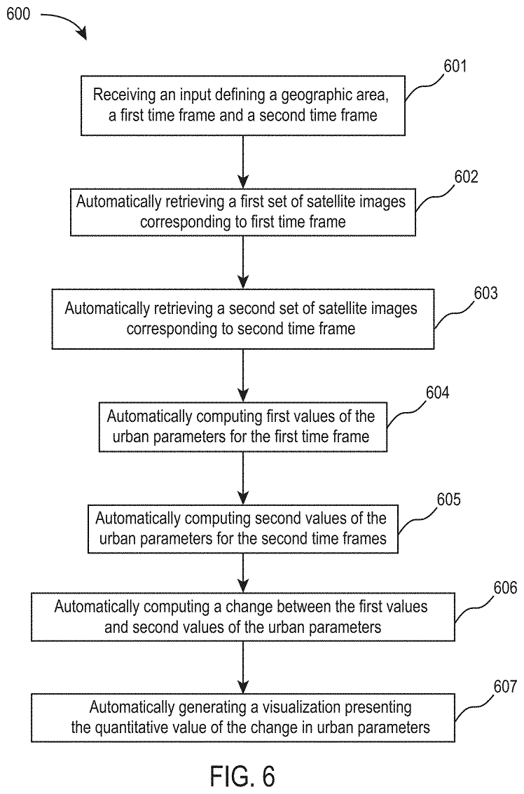

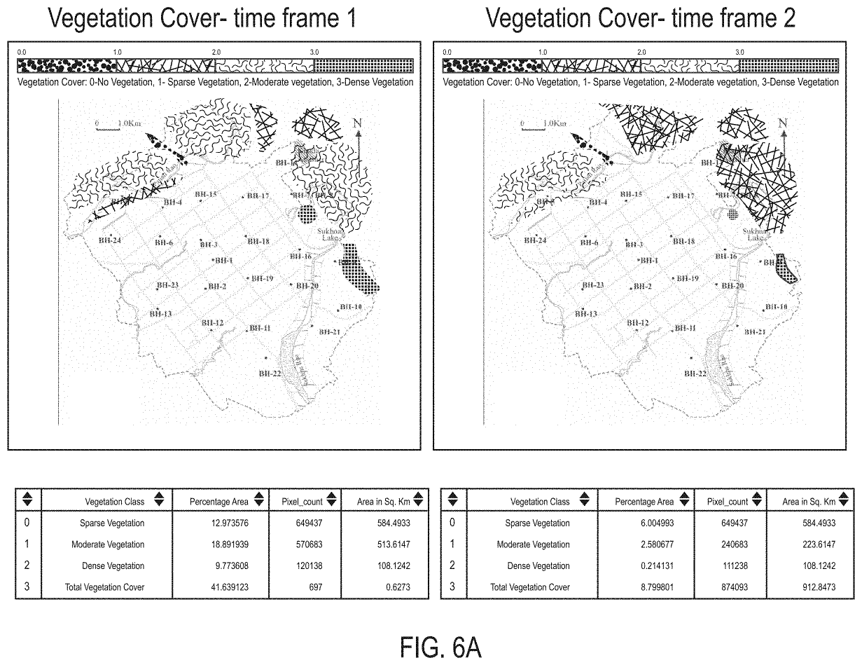

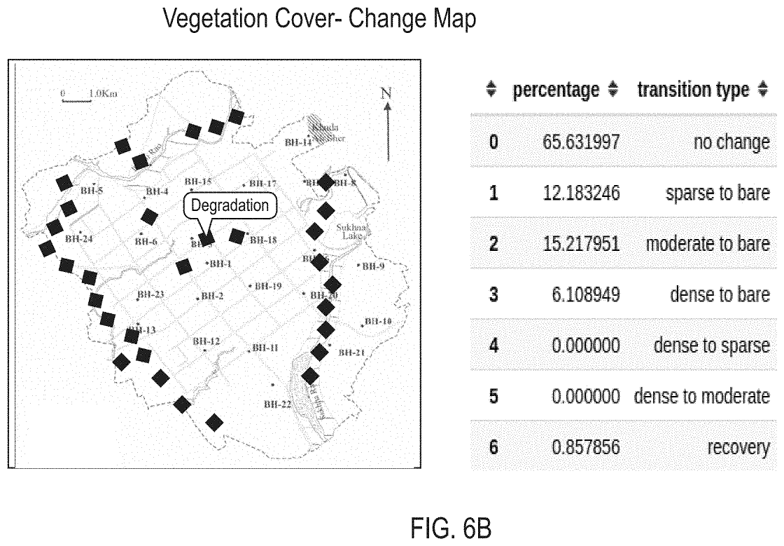

FIG. 6 schematically shows an exemplary flow diagram 600 for detecting change in urban parameters over different time frames.

At step 601, a first input defining a geographic area and a first time frame and a second input defining a second time frame is received from the user. The inputs are intended towards change detection in urban parameters of same type between the first and the second time frame for the defined geographic area.

At step 602, a first set of images corresponding to the defined geographic area and the first time frame are automatically selected and retrieved from the one or more servers.

At step 603, a second set of images corresponding to the defined geographic area and the second time frame are automatically selected and retrieved from the one or more servers.

At step 604, first values of at least one of the urban parameters are automatically computed using the first set of satellite images for the first time frame as described in detail in FIGS. 1 to 5.

At step 605, second values of at least one of the urban parameters are automatically computed using the second set of satellite images for the second time frame as described in detail in FIGS. 1 to 5.

At step 606, a change between the first values and second values of the urban parameters is computed.

At step 607, a visualization presenting the quantitative value of the change in urban parameters between the first time frame and the second time frame is automatically generated. In some examples, a change map representing the quantitative statistical measurements of the urban parameters for first time frame and second time frame is automatically generated and presented on an image of the geographic area. In some examples, the change map shows the relative changes in similar class, generated from the comparison with respective thresholds, of the one or more spectral indices representing the urban parameters, between the first time frame and the second time frame. In some examples, markers depicting an increase or decrease in the urban parameters between the first time frame and the second time frame are also presented on an image or a map of the geographic area. In some examples, percentage change in area covered by each class of the urban parameter is generated and presented on an image or a map of the geographic area.

As an example, FIG. 6(a) shows the vegetation cover for the first time frame and the second time frame over the defined geographic area. As an example, FIG. 6(b) shows the change map of the vegetation cover between the first time frame and second time frame.

One skilled in the art will appreciate that above described visualization presenting the quantitative value of the change in urban parameters between the first time frame and the second time frame has been described with reference to vegetation cover for the purpose of illustration only and shall not be considered as limiting the scope of the description in any way. A similar visualization presenting the quantitative value of the change in any of the other urban parameters described herein and/or any number of time frames shall be considered within the spirit and scope of the present description.

One skilled in the art will appreciate that, for this and other methods disclosed herein, the functions performed in the methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

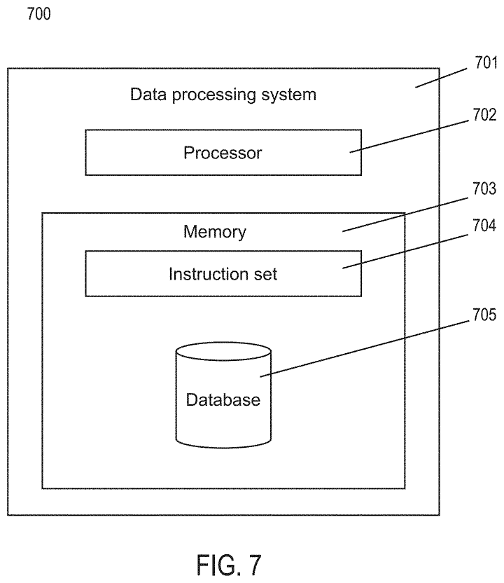

FIG. 7 schematically shows a block diagram of an illustrative example of a system 700 for geospatial analysis for determining and presenting urban parameters and detecting a change in urban parameters between different time frames, arranged in accordance with at least some embodiments described herein. As depicted in FIG. 7, the system 700 includes a data processing system 701, which comprises at least one processor 702 and at least one memory 703. The memory 703 comprises an instruction set storage 704 and a database 705. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof. The system components may be provided by one or more server computers and associated components.

In some examples, the data processing system 701, with use of the processor 702, may be configured, based on execution of one or more instructions stored on the instruction set storage 704 and/or database 705, to perform some or all the operations of the methods 100, 200, 300, 400, 500 and/or 600 as detailed above.

It is to be noted herein that various aspects and objects of the present invention described above as methods and processes should be understood to an ordinary skilled in the art as being implemented using a system that includes a computer that has a CPU, display, memory and input devices such as a keyboard and mouse. According to an embodiment, the system is implemented as computer readable and executable instructions stored on a computer readable media for execution by a general or special purpose processor. The system may also include associated hardware and/or software components to carry out the above described method functions. The system is preferably connected to an internet connection to receive and transmit data.

The term “computer-readable media” as used herein refers to any medium that provides or participates in providing instructions to the processor of the computer (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Although the present invention has been described in terms of certain preferred embodiments, various features of separate embodiments can be combined to form additional embodiments not expressly described. Moreover, other embodiments apparent to those of ordinary skill in the art after reading this disclosure are also within the scope of this invention. Furthermore, not all of the features, aspects and advantages are necessarily required to practice the present invention. Thus, while the above detailed description has shown, described, and pointed out novel features of the invention as applied to various embodiments, it will be understood that various omissions, substitutions, and changes in the form and details of the apparatus or process illustrated may be made by those of ordinary skill in the technology without departing from the spirit of the invention. The inventions may be embodied in other specific forms not explicitly described herein. The embodiments described above are to be considered in all respects as illustrative only and not restrictive in any manner. Thus, scope of the invention is indicated by the following claims rather than by the above description.

What is claimed is:

1. A computer-implemented method for geo-spatial analysis, said method comprising:
receiving a first input defining a geographic area and a first time frame;
automatically retrieving a first set of satellite images corresponding to the geographic area and the first time frame;
automatically processing the first set of satellite images to determine first values of one or more urban parameters corresponding to the geographic area for the first time frame; and
automatically presenting a visualization depicting the first values of the one or more urban parameters.

2. The computer-implemented method of claim 1, wherein the one or more urban parameters includes at least one of a surface parameter and an environmental parameter.

3. The computer-implemented method of claim 2, wherein:
the surface parameter includes at least one of vegetation cover, surface water cover, built up area, vegetation moisture level, crop land cover, fallow land cover, and barren land; and
the environmental parameter includes at least one of land surface temperature, urban heat island effect, urban sprawl, and groundwater potential zone.

4. The computer-implemented method of claim 1, wherein said automatically retrieving a first set of satellite images includes automatically selecting and retrieving satellite images with at most 5 percent cloud coverage from one or more servers.

5. The computer-implemented method of claim 1, wherein said automatically retrieving a first set of satellite images includes automatically retrieving level-1 precision and terrain (L1TP) corrected satellite images from one or more servers.

6. The computer-implemented method of claim 3, wherein said automatically processing the first set of satellite images to determine first values of one or more urban parameters includes:
automatically converting digital numbers of each pixel of one or more spectral band images, corresponding to the first set of satellite images, into reflectance values of the respective spectral bands using radiometric calibration; and
automatically computing one or more spectral indices, corresponding to the one or more urban parameters, for each pixel of the first set of satellite images using the corresponding reflectance values.

7. The computer-implemented method of claim 6, wherein said automatically retrieving a first set of satellite images includes automatically retrieving said one or more spectral bands or images corresponding to the one or more urban parameters.

8. The computer-implemented method of claim 6, wherein said automatically processing the first set of satellite images to determine first values of one or more urban parameters includes automatically fetching said one or more spectral band images, corresponding to the one or more urban parameters, from the first set of satellite images.

9. The computer-implemented method of claim 6, wherein the one or more spectral indices include at least one of normalized difference vegetation index (NDVI), modified normalized difference water index (MNDWI), index based built up index (IBI), normalized difference built up index (NDBI), normalized difference moisture index (NDMI), optimized soil adjusted vegetation index (OSAVI), and barren land index (BLI).

10. The computer-implemented method of claim 6, wherein the one or more urban parameters include the one or more surface parameters and the computer-implemented method further comprises:
automatically comparing each of the one or more spectral indices, for each pixel of the first set of satellite images, with a respective predefined threshold; and
automatically classifying each pixel of the first set of satellite images, with respect to each of the one or more spectral indices, based on the respective comparison.

11. The computer-implemented method of claim 10, wherein said automatically presenting a visualization depicting the first values of the one or more urban parameters includes automatically presenting the classified pixels, and respective classification, on an image of the geographic area.

12. The computer-implemented method of claim 10, wherein the computer-implemented method further comprises automatically calculating a quantitative value of an area covered by pixels of each class, and said automatically presenting a visualization depicting the first values of the one or more urban parameters includes automatically presenting the area covered by the pixels of each class on an image of the geographic area.

13. The computer-implemented method of claim 9, wherein the environmental parameter includes the land surface temperature, and the one or more spectral indices includes the NDVI, and computer-implemented method further comprises:
automatically computing surface emissivity for each pixel of the first set of satellite images using the respective NDVI;
automatically converting digital numbers of each pixel of one or more thermal infrared spectral band images, corresponding to the first set of satellite images, into radiance values of respective thermal infrared spectral bands;
automatically converting the radiance values of each pixel of the first set of satellite images into respective satellite brightness temperature; and
automatically computing the land surface temperature for each pixel of the first set of satellite images using the respective satellite brightness temperature and the respective surface emissivity;
wherein said automatically presenting a visualization depicting the first values of the one or more urban parameters includes automatically presenting the land surface temperature for each pixel on an image of the geographic area.

14. The computer-implemented method of claim 13, wherein the environmental parameter includes the urban heat island effect and the computer-implemented method further comprises:
automatically normalizing the land surface temperature values for each pixel of the first set of satellite images;
automatically comparing each of the normalized land surface temperature values with a predefined threshold; and
automatically classifying each pixel of the first set of satellite images, with respect to the normalized land surface temperature values, based on the respective comparison;
wherein said automatically presenting a visualization depicting the first values of the one or more urban parameters includes automatically presenting the classified pixels, and respective classification, on an image of the geographic area.

15. The computer-implemented method of claim 13, wherein said automatically presenting a visualization depicting the first values of the one or more urban parameters includes automatically presenting grid wise information of the land surface temperature on an image of the geographic area.

16. The computer-implemented method of claim 9, wherein the environmental parameter includes the urban sprawl, the surface parameter includes the built up area, and the one or more spectral indices include IBI, and the computer-implemented method further comprises:
automatically computing shannon's entropy for the geographic area using the built up area; and
automatically determining the urban sprawl corresponding to the geographic area, based on the shannon's entropy;
wherein said automatically presenting a visualization depicting the first values of the one or more urban parameters includes automatically presenting the urban sprawl on an image of the geographic area.

17. The computer-implemented method of claim 9, wherein the environmental parameter includes the groundwater potential zone cover and the one or more spectral indices include the NDVI, MNDWI, NDBI, and NDMI, the computer-implemented method further comprises:
automatically retrieving slope data of the geographic area from Shuttle Radar Topography Mission (SRTM) Digital elevation model;
automatically computing topographic wetness index (TWI) using the SRTM slope data; and
automatically computing the groundwater potential zone cover via analytic hierarchy process (AHP) and weighted sum approach using the NDVI, MNDWI, NDBI, NDMI, and the topographic wetness index;
wherein said automatically presenting a visualization depicting the first values of the one or more urban parameters includes automatically presenting the groundwater potential zone cover on an image of the geographic area.

18. The computer-implemented method of claim 1, wherein the first set of satellite images includes Moderate Resolution Imaging Spectroradiometer (MODIS) satellite images and the one or more urban parameters includes particulate matter (PM) concentration, and the computer-implemented method further comprises:
automatically retrieving aerosol optical depth (AOD) product from the MODIS satellite images;
automatically retrieving ground-based PM concentration data, and meteorological data; and
automatically computing the PM concentration from the AOD product, the ground-based PM concentration data, and the meteorological data using linear regression model;
wherein said automatically presenting a visualization depicting the first values of the one or more urban parameters includes automatically presenting the particulate matter (PM) concentration on an image of the geographic area.

19. The computer-implemented method of claim 1, the computer-implemented method further comprises:
receiving a second input defining a second time frame;
automatically retrieving a second set of satellite images corresponding to the geographic area and the second time frame;
automatically processing the second set of satellite images to determine second values of the one or more urban parameters corresponding to the geographic area for the second time frame;
automatically presenting a visualization depicting a comparison of the first and the second values of the one or more urban parameters, the comparison illustrating a quantitative relative change in the one or more urban parameters corresponding to the geographic area over a time duration from the first time frame to the second time frame.

20. A system for geo-spatial analysis, said system comprising:
at least one processor; and
a memory that is coupled to the at least one processor and that includes computer-executable instructions, wherein the at least one processor, based on execution of the computer-executable instructions, is configured to perform the method of claim 1

21. A computer-readable medium that comprises computer-executable instructions that, based on execution by at least one processor of a computing device that includes memory, cause the computing device to perform one or more steps of the method of claim 1.
